(19) United States
(12) Patent Application Publication
(10) Pub. No.: US 2012/0318736 A1
(43) Pub. Date: Dec. 20, 2012

(54) SPIRAL-TYPE FILTRATION MODULE, AND LIQUID TREATMENT METHOD AND DEVICE EMPLOYING THE SAME

(75) Inventors: Kenichi SAITO, Tokyo (JP); Toshio SANO, Tokyo (JP)

(73) Assignee: Yuasa Membrane Systems Co., Ltd., Tokyo (JP)

(21) Appl. No.: 13/523,056

(22) Filed: Jun. 14, 2012

(30) Foreign Application Priority Data
Jun. 17, 2011 (JP) 2011-135260

(51) Int. Cl. B01D 63/10; B01D 61/00; C02F 1/44; B01D 65/02; C02F 103/08

(52) U.S. Cl. 210/636; 210/321.83; 210/650

(57) ABSTRACT

The present invention provides a spiral-type filtration module including a liquid collection tube, and one or more units each including a first filtration membrane, a permeated-liquid flow-path member, a second filtration membrane, and a raw-liquid flow-path member, which are laminated on each other, wherein the one or more units are wound around the liquid collection tube to form a spiral-type membrane element, and the spiral-type membrane element is housed in a substantially-cylindrical outer container. In the permeated-liquid flow-path member, there are formed partition members for inhibiting a permeated liquid from flowing in a module axial direction.

### BACKGROUND OF THE INVENTION

1. Field of the Invention

The present invention relates to a spiral-type filtration module for use in solid-liquid separation. More specifically, the present invention relates to a spiral-type filtration module suitable for filtration processing for larger amounts of permeated liquids.

2. Description of the Related Art

Conventionally, spiral-type filtration modules have been employed for separation and elimination of contamination substances from various types of waste liquids, pretreatment of reverse osmosis membrane devices, and the like.

FIG. 2 illustrates a general structure of a spiral-type filtration module. Around a hollow liquid collection tube 2 having a plurality of holes in its side surface, there are wound one or more units each constituted by a first filtration membrane 3, a permeated-liquid flow-path member 4, a second filtration membrane 5, and a raw-liquid flow-path member 6 which are laminated on each other, thereby forming a spiral-type membrane element. This spiral-type membrane element is housed in a substantially-cylindrical outer container 7.

Filtrations utilizing such a spiral-type module are performed through cross-flow operations. That is, a raw liquid is supplied to a raw-liquid flow path 16 through a raw-liquid inlet 11 and, a portion thereof passes through the filtration membranes 3 and 5, further passes through a permeated-liquid flow path 14 and is extracted therefrom through a permeated-liquid outlet 12 (hereinafter referred to as “permeated liquid”), while the remainder thereof passes through the raw-liquid flow path 16 and is ejected through a concentrated-liquid outlet 13 (hereinafter referred to as “condensed liquid” or “non-permeated liquid”). In typical cross-flow operations, the recovery, which is expressed as the ratio of the amount of the permeated liquid to the amount of the supplied raw liquid, is about 1/50 to 1/15.

Solid substances contained in the raw liquid are trapped by the filtration membranes 3 and 5, and are deposited on their surfaces closer to the raw-liquid flow path 16. Therefore, such solid substances are eliminated by flushing or back washing at regular or irregular time intervals. In common flushing methods, a flushing liquid is supplied through the raw-liquid inlet 11 while closing the permeated-liquid outlet 12, for eliminating substances deposited on the filtration-membrane surfaces, and the substances are discharged therefrom, together with the flushing liquid through the concentrated-liquid outlet 13. In common back-washing methods, a back-washing liquid is supplied through the permeated-liquid outlet 12, and deposited substances are discharged through the raw-liquid inlet 11 and/or the concentrated-liquid outlet 13.

In cross-flow operations, by lowering the recovery, it is possible to obtain an effect of washing the filtration-membrane surfaces with the flow of the raw liquid, which can reduce the amount of solid substances deposited on the filtration-membrane surfaces. This enables elongating a continuous filtration-operating time period between flushing and the next flushing. On the other hand, if the recovery is lower, this induces the problem of an increase of the cost of the entire filtration system, due to necessity for a raw-liquid supply pump having higher ability with respect to the amount of the permeated liquid, or the like.

Therefore, there have been made attempts to perform higher-yield operations for reducing the amounts of non-permeated liquids to increase the recovery, and to perform dead-end filtration operations for nulling the amounts of non-permeated liquids. For example, JP-A-10-235164 and JP-A-10-235166 disclose water treatment systems adapted to perform dead-end filtration operations using spiral-type membrane modules.

In higher-yield operations and dead-end filtration operations, greater amounts of solid substances are deposited on the filtration-membrane surfaces, which essentially necessitates reliable elimination of such substances deposited on the filtration-membrane surfaces, through flushing and the like. However, the present inventors faced problems relating to elimination of such filtration-membrane-surface deposited substances, when performing higher-yield operations and dead-end filtration operations using a spiral-type filtration module.

When back-washing was performed, after the back-washing liquid supplied through the permeated-liquid outlet 12 had eliminated deposited substances near the concentrated-liquid outlet 13, the back-washing liquid preferentially passed through this portion. As a result, deposited substances in the upstream (the side closer to the raw-liquid inlet 11, and the same applies hereinafter) and in the midstream of the module were not eliminated.

Further, when flushing was performed, after the flushing liquid supplied through the raw-liquid inlet 11 had eliminated deposited substances near the raw-liquid inlet 11, a portion of the flushing liquid passed through the filtration membranes 3 and 5 to be diverted to the permeated-liquid flow path 14, further passed through the filtration membranes 3 and 5 again in the opposite direction near the permeated-liquid outlet 12, and then, was ejected therefrom through the concentrated-liquid outlet 13, thereby inducing a flushing-liquid bypassing phenomenon. As a result, deposited substances in the midstream of the module were not eliminated. Further, when there was a deposited-substance layer having a lower liquid-permeation resistance, even when deposited substances near the raw-liquid inlet 11 had not been eliminated, the flushing liquid passed through the deposited-substance layer and the filtration membranes to be diverted to the permeated-liquid flow path, thereby inducing a bypass phenomenon, in some cases.

Such bypass phenomena had smaller influences in cases where the filtration membranes 3 and 5 were formed from reverse osmosis membranes or nano-filtration membranes having smaller pore sizes. However, such bypass phenomena had larger influences when the filtration membranes were formed from ultra-filtration membranes or micro-filtration membranes. Further, such bypass phenomena were particularly prominent, in cases of employing a module having a larger amount of a permeated liquid, which was suitable for higher-yield operations and dead-end filtration operations.

### SUMMARY OF THE INVENTION

An object of the present invention is to provide a spiral-type filtration module capable of certainly eliminating substances deposited on filtration-membrane surfaces, in view of the aforementioned circumstances. Along therewith, another object is to provide a liquid treatment method using such a spiral-type filtration module.

A first aspect of the present invention provides a spiral-type filtration module including a liquid collection tube, and one or more units each including a first filtration membrane, a permeated-liquid flow-path member, a second filtration membrane, and a raw-liquid flow-path member which are laminated on each other, the one or more units being wound around the liquid collection tube to form a spiral-type membrane element, and the spiral-type membrane element being housed in an outer container, wherein the permeated-liquid flow-path member includes partition members for inhibiting a permeated liquid from flowing in a module axial direction.

Since the partition members are formed in the permeated-liquid flow-path member, it is possible to alleviate the influence of flushing-liquid bypassing phenomena, thereby certainly eliminating substances deposited on the filtration-membrane surfaces.

Control utilizing the partition members is preferably performed, in such a way as to secure a path for flowing filtered water therethrough, even through the direction of bypass is partitioned by the liquid collection tube. For example, in cases of a hollow fiber module, its permeate side also functions as a water-collection path and, therefore, if a bypass is provided, this will directly inhibit the flow of the filtered water.

A second aspect of the present invention provides the spiral-type filtration module in the first aspect, wherein, preferably, the first filtration membrane and the second filtration membrane have a nominal pore size of 0.01 to 10 μm.

In this case, the nominal pore size refers to a membrane pore size capable of trapping 98% of particles with a size corresponding thereto.

When the filtration membranes have a nominal pore size within this range, flushing-liquid bypassing phenomena tend to have larger influences, and also, the filtration membranes can be effectively washed through flushing, which enables exerting the effects of the present invention more prominently.

A third aspect of the present invention provides the spiral-type filtration module in the first aspect, wherein, preferably, the filtration module is adapted such that an amount of the permeated liquid per an effective membrane area of the filtration membranes is 0.5 to 4 L/min·m².

In this case, the effective membrane area of the filtration membranes refers to the membrane area within the entire membrane area, other than the membrane areas of the portions having no filtering function, such as the peripheral-edge sealed portions. The amount of the permeated liquid refers to an amount of the permeated water which is averaged over 24 hours, when pure water is supplied at a pressure of 200 kPa, where the amount of the permeated liquid is expressed using a unit time period and a unit effective membrane area.

Such a filtration module suitable for high-yield operations and dead-end filtration operations has a tendency to induce a larger amount of flushing-liquid bypassing flows, and therefore, the effects of the present invention can be exerted more prominently.

A fourth aspect of the present invention provides the spiral-type filtration module in the first aspect, wherein, preferably, the partition members are formed in a linear shape in the permeated-liquid flow-path member, from a portion proximal to the liquid collection tube to an element outer periphery.

A fifth aspect of the present invention provides the spiral-type filtration module in the fourth aspect, wherein, more preferably, the partition members formed in the linear shape are such that there is an interval of 105 to 420 mm between adjacent partition members in the module axial direction.

With these structures, it is possible to alleviate influences of flushing-liquid bypassing phenomena more effectively.

A sixth aspect of the present invention provides a liquid treatment method using any of the aforementioned spiral-type filtration modules, wherein a ratio of an amount of the permeated liquid filtered/recovered by the module to an amount of a raw liquid supplied to the module, that is, the recovery, is equal to or more than 1/10.

By employing any of the aforementioned spiral-type modules, it is possible to certainly eliminate substances deposited on the filtration-membrane surfaces, which enables higher-yield operations or dead-end filtration operations as described above.

A seventh aspect of the present invention provides the liquid treatment method in the sixth aspect, wherein, preferably, the raw liquid contains solid substances in a concentration of 1000 ppm or less. An eighth aspect of the present invention provides the liquid treatment method in the sixth aspect, wherein, preferably, the raw liquid is seawater, river water, or industrial water.

The liquid treatment method according to the present invention is attained by high-yield operations or dead-end filtration operations as described above, and is particularly suitable for processing for filtering raw liquids having smaller solid contents.

A ninth aspect of the present invention provides the liquid treatment method in the sixth aspect, wherein, preferably, the filtration module is washed by flushing at regular or irregular time intervals, and a flushing liquid is supplied at a pressure of 300 kPa or less, during the flushing.

By maintaining the supply pressure for the flushing liquid at a lower pressure, it is possible to reduce the amount of the used flushing liquid and the amount of the ejected liquid after the washing through the flushing. Further, with the liquid treatment method according to the present invention, it is possible to reduce the flow rate of bypassing flushing liquid, which enables effective washing even with a reduced amount of the flushing liquid.

A tenth aspect of the present invention provides the liquid treatment method in the sixth aspect, wherein, preferably, the filtration module is washed by flushing at regular or irregular time intervals, before the flushing, a module-interior pressure-equalization manipulation is performed by supplying a flushing liquid while closing a permeated-liquid outlet and an outlet for ejecting the flushing liquid in the filtration module, and after the pressure-equalization manipulation, only the outlet for ejecting the flushing liquid is opened for performing the flushing.

By opening only the outlet for ejecting the flushing liquid after the manipulation for pressure equalization within the module, it is possible to facilitate exfoliation of substances deposited on the filtration-membrane surfaces, from the filtration-membrane surfaces. Further, by using the spiral-type filtration module according to the present invention, it is possible to exert this effect of facilitating exfoliation of deposited substances, on wider ranges in the filtration membranes.

An eleventh aspect of the present invention provides the liquid treatment method in the sixth aspect, wherein, more preferably, the flushing is performed in such a way as to change over between forward flushing for supplying the flushing liquid through a raw-liquid inlet in the filtration module and rearward flushing for supplying the flushing liquid through a concentrated-liquid outlet in the filtration module, every time the flushing has been performed one or more times.

By properly reversing the direction of flushing, it is possible to exert the aforementioned deposited-substance exfoliation facilitating effect, on wider ranges in the filtration membranes.

### BRIEF DESCRIPTION OF THE DRAWINGS

The foregoing and other features of the invention will become apparent to one skilled in the art to which the present invention relates upon consideration of the invention with reference to the accompanying drawings, wherein:

FIG. 1 shows a structural view of a spiral-type filtration module according to an embodiment of the present invention;

FIG. 2 shows a structural view of a conventional spiral-type filtration module;

FIG. 3 shows a view of a configuration of a filtration system using the spiral-type filtration module;

FIG. 4 shows a conceptual view of a cross-flow operation;

FIG. 5 shows a conceptual view of a dead-end filtration operation;

FIG. 6 shows a conceptual view of flushing;

FIG. 7 shows a conceptual view of a flushing-liquid bypassing phenomenon;

FIG. 8 shows a conceptual view of suppression of flushing-liquid bypassing phenomena with the filtration module according to the present invention;

FIG. 9 shows a view of a configuration of a model experiment device;

FIG. 10 shows a conceptual view illustrating a change of the shape of a filtration membrane during a filtration operation;

FIG. 11 shows a conceptual view illustrating a change of the shape of the filtration membrane during a pressure-equalization manipulation; and

FIG. 12 shows a conceptual view illustrating a change of the shape of the filtration membrane during flushing after the pressure-equalization manipulation.

### DETAILED DESCRIPTION OF THE INVENTION

Preferred embodiments of the present invention will be described hereinafter.

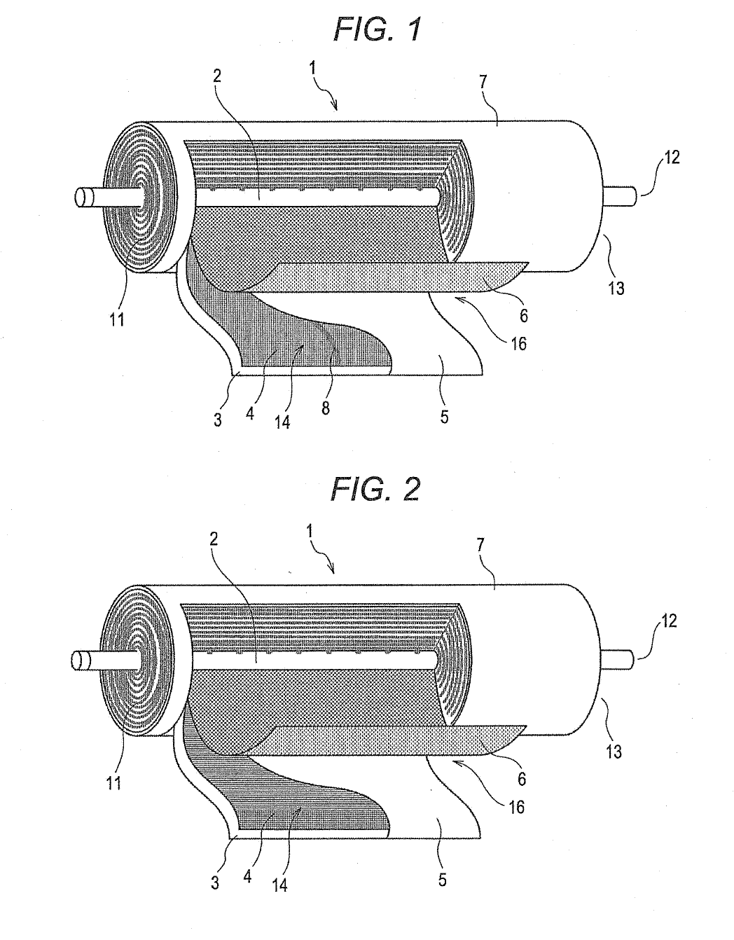

An embodiment of a spiral-type filtration module according to the present invention will be described with respect to the structure and the constituents thereof, with reference to FIG. 1.

A spiral-type filtration module 1 according to the present embodiment includes a hollow liquid collection tube 2 having a plurality of holes in its side surface, and further includes one or more units each constituted by a filtration membrane 3, a permeated-liquid flow-path member 4, a filtration membrane 5, and a raw-liquid flow-path member 6 which are laminated on each other, such that the one or more units are wound around the liquid collection tube 2, thereby forming a spiral-type membrane element. The spiral-type membrane element is housed in a substantially-cylindrical outer container 7. The filtration membrane 3 and the filtration membrane 5 form a bag member which is closed at three sides thereof, and communicates with the liquid collection tube 2 at the other side thereof. The raw-liquid flow-path member 6 exists outside the bag member to form a raw-liquid flow path 16, and the raw-liquid flow path 16 communicates with the outside through a raw-liquid inlet. 11 and a concentrated-liquid outlet 13 at the opposite ends of the filtration module 1. Inside the bag member, there is the permeated-liquid flow-path member 4 to form a permeated-liquid flow path 14 which communicates with the liquid collection tube 2. The liquid collection tube 2 is sealed at its one end, and forms a permeated-liquid outlet 12 at the other end thereof (the side closer to the concentrated-liquid outlet 13 in FIG. 1).

In the spiral-type filtration module 1 according to the present invention, partition members 8 are formed in the permeated-liquid flow-path member 4. The partition members 8 are for partitioning the permeated-liquid flow path 14 into a plurality of sections for inhibiting a permeated liquid from flowing in the module axial direction. This can suppress the occurrence of bypass phenomena in which a flushing liquid flows through the permeated-liquid flow path 14 during flushing.

In the present embodiment, the partition members 8 are formed in the permeated-liquid flow-path member 4 from its portion proximal to the liquid collection tube 2 up to the element outer periphery. Since the partition members 8 function to increase the flow resistance against the flushing liquid flowing through the permeated-liquid flow path 14 in the module axial direction, the partition members 8 are not required to completely intercept the flow in the module axial direction. Accordingly, the permeated liquid is allowed to flow in the module axial direction through the gaps between the membranes and the partition members. Further, the partition members 8 are not necessarily formed continuously over the entire width of the permeated-liquid flow-path member 4 from its end proximal to the liquid collection tube 2 to its element-outer-periphery-side end, and the partition members 8 can be made shorter than the entire width. Also, the partition members 8 may be interrupted at some portions, and may be intermittently formed in the permeated-liquid flow-path member 4 from its portion proximal to the liquid collection tube 2 up to the element outer periphery.

If the partition members 8 have an excessively-small width, a sufficient strength cannot be obtained. In cases of employing a net as the permeated-liquid flow-path member 4, it is preferable that the partition members 8 have a width equal to or larger than the interval between filaments, in order to cause the material forming the partition members 8 to be adhered to the filaments of the net over sufficiently-large areas. For example, in cases where the density of the filaments in the permeated-liquid flow-path member 4 which is a net is 4 filaments/cm, the partition members 8 can be made to have a width equal to or more than 2.5 mm. In cases of employing a member other than a net as the permeated-liquid flow-path member 4, the partition members 8 preferably have a width equal to or greater than 2 mm. On the other hand, if the partition members 8 have an excessively-large width, this reduces the area of the permeated-liquid flow path 14 and the effective membrane areas of the filtration membranes. Accordingly, it is preferable that the partition members 8 have a width equal to or less than 10 mm.

The interval between the partition members 8 can be determined based on the viscosity of the raw liquid to be treated, the content of solid substances, the flow resistance of the raw-liquid flow path 16, the flow resistance of the permeated-liquid flow path 14, the throughput of the filtration module, and other parameters. If the interval between the partition members is excessively small, this reduces the area of the permeated-liquid flow path 14. If the interval between the partition members is excessively large, this significantly increases the influences of flushing-liquid-bypass phenomena which may occur within the sections in the permeated-liquid flow path 14 partitioned by the partition members. Results of experiments conducted by the present inventors have revealed that the interval between the partition members preferably falls within the range of 105 to 420 mm and, more preferably, falls within the range of 105 to 300 mm.

As the filtration membranes 3 and 5, it is possible to employ flat membranes for various types of applications, such as micro filtration, ultra filtration, and nano filtration. However, among them, it is preferable to employ micro-filtration membranes or ultra-filtration membranes.

On the other hand, such micro-filtration membranes and ultra-filtration membranes have not been confirmedly defined through specification of their pore sizes and the like. Furthermore, there has been no clear boundary between the micro-filtration membranes and the ultra-filtration membranes. Rikagaku Jiten (Iwanami, Fifth Edition) mentions that micro filtration is filtration for particles with particle sizes in the range of 0.02 to 10 μm, while ultra filtration is filtration for particles with particle sizes in the range of 0.001 to 1 μm (with molecular weights in the range of 1000 to 300000). Therefore, filtration membranes having equivalent pore sizes may be referred to as either micro-filtration membranes or ultra-filtration membranes. Herein, the term “micro filtration” and the term “ultra filtration” will be used tentatively according to the aforementioned definitions, but nominal pore sizes will be used in cases of accurately defining the pore sizes. The nominal pore size refers to the diameter of particles, when the particles having a size corresponding thereto can be trapped by 98%.

In expression using the nominal pore sizes, it is preferable that the filtration membranes have nominal pore sizes in the range of 0.01 to 10 μm. Further, more preferably, the filtration membranes have nominal pore sizes in the range of 0.01 to 1 μm. If the filtration membranes have nominal pore sizes smaller than 0.01 μm, this makes the filtration resistance thereof higher, which reduces the flow rate of the bypassing flushing liquid even with conventional spiral-type filtration modules, thereby causing the present invention to less exert its effect. On the other hand, if the filtration membranes have excessively-large nominal pore sizes, this makes it harder to eliminate substances deposited on the filtration-membrane surfaces through flushing. If their nominal pore sizes exceed 10 μm, a major part of solid substances trapped in the filtration membranes intrudes into the insides of fine pores, which makes it impossible to eliminate such solid substances within the fine pores only by flushing. If the filtration membranes have nominal pore sizes larger than 1 μm, a portion of solid substances trapped in the filtration membranes intrudes into the insides of fine pores, which makes it difficult to completely eliminate the solid substances within the fine pores only by flushing.

As the micro-filtration membranes or the ultra-filtration membranes which are employed as the filtration membranes 3 and 5, it is possible to employ filtration membranes formed from a base material made of a synthetic-resin non-woven fabric, and a polymer membrane having a plurality of fine pores which is formed on the surface of the base member, for example.

As a method for fabricating the bag member formed from the filtration membranes 3 and 5, it is possible to employ various methods similar to those for conventional spiral-type modules. For example, it is possible to employ a method which adheres sheet-type filtration membranes to each other at three sides thereof through heat fusion bonding or an adhesive agent, a method which folds band-shaped filtering membranes in a zigzag shape and adheres them to each other at two lateral sides thereof through heat fusion bonding or an adhesive agent, or the like.

As the raw-liquid flow-path member 6, as long as it can maintain the interval between the filtration membranes 3 and 5 to ensure that the raw liquid flows therethrough, it is possible to employ any of members which have various shapes and are made of various materials, similarly to those in conventional spiral-shaped modules. For example, it is possible to employ any of woven knitted fabrics and nets which are formed from fibers made of synthetic resins, such as polyolefin-based, polyester-based, and polyamide-based resins. Among them, it is more preferable to use a net having meshes formed from filaments sterically intersecting with each other, since the use of such a net can lower the flow resistance against the flushing liquid for washing away filtration-membrane-surface deposited substances.

In cases of employing a net as the raw-liquid flow-path member 6, it is preferable that the net has a thickness in the range of 0.5 to 1 mm. When the filaments forming the meshes are sterically intersected with each other, the net thickness is a little less than twice the filament diameter.

If the net thickness is less than 0.5 mm, even a small amount of filtration-membrane-surface deposited substances tends to induce clogging between the membranes, and even smaller particles lodged therein may make it difficult to attain washing through flushing. On the contrary, if the thickness thereof is larger than 1 mm, this widens the raw-liquid flow path, thereby necessitating a larger flow rate of the flushing liquid for attaining effective flushing.

It is preferable that the net used as the raw-liquid flow-path member 6 has such a mesh size in which the density of the filaments arranged in parallel therein (the number of filaments per unit length) is 3 to 7 filaments/cm.

If the net has an excessively-large mesh size, that is, if the density of the filaments is less than 3 filaments/cm, this induces concentrations of stresses in the filtration membranes at the sterical intersections of the filaments, which tends to cause damages of the filtration membranes. Furthermore, in such cases, the flow resistance is made excessively low, which may inhibit the flushing liquid from flowing uniformly therethrough. On the contrary, if the density of the filaments is larger than 7 filaments/cm, this makes the flow resistance in the raw-liquid flow path 16 excessively high.

As the permeated-liquid flow-path member 4, as long as it can maintain the interval between the filtration membranes 3 and 5 to ensure that the permeated liquid flows therethrough, it is possible to employ any of members which have various shapes and are made of various materials. For example, it is possible to employ any of woven knitted fabrics and nets which are formed from fibers made of synthetic resins, such as polyolefin-based, polyester-based, and polyamide-based resins. In many cases, conventional spiral-type filtration modules have employed woven knitted fabrics having fine meshes and larger flow resistances, as permeated-liquid flow-path members. On the contrary, in the module according to the present embodiment, it is desirable to employ the permeated-liquid flow-path member 4 having rougher meshes and a lower flow resistance, in order to increase the flow rate of the permeated liquid during higher-yield operations or during dead-end filtration operations. Therefore, as the permeated-liquid flow-path member 4, it is preferable to employ a net having meshes which are formed from filaments sterically intersecting with each other, similarly to the raw-liquid flow-path member 6.

In cases of employing a net as the permeated-liquid flow-path member 4, it is preferable that the net has a thickness in the range of 0.5 to 1 mm. When the filaments forming the meshes are sterically intersected with each other, the net thickness is a little less than twice the filament diameter.

If the net thickness is smaller than 0.5 mm, this narrows the permeated-liquid flow path 14, thereby making it difficult to ensure the permeated liquid flows therethrough. On the contrary, if the thickness thereof is excessively large, this causes the module to have an unnecessarily-large capacity.

It is preferable that the net used as the permeated-liquid flow-path member 4 has a mesh size in which the density of the filaments arranged in parallel therein (the number of filaments per unit length) is 3 to 9 filaments/cm.

If the net has an excessively-large mesh size, that is, if the density of the filaments is smaller than 3 filaments/cm, this induces concentrations of stresses in the filtration membranes at the sterical intersections of the filaments, which tends to cause damages to the filtration membranes. Further, since the membranes are supported at a smaller number of points, the filtration membranes 3 and 5 tend to come close to each other, which makes it difficult to ensure the permeated liquid flows therethrough depending on the net thickness. On the other hand, in cases where the net thickness falls within the aforementioned range of 0.5 to 1 mm, if the density of the filaments is larger than 9 filaments/cm, this makes the flow resistance in the permeated-liquid flow path 14 excessively high.

The material of the partition members 8 formed on the permeated-liquid flow-path material 4 can be selected, in consideration of the durability, and the components which can be eluted into the permeated liquid. For example, it is possible to employ various types of synthetic resins, such as polyolefin-based, ethylene-vinyl-acetate-based, silicone-based, and polyurethane-based resins. Among them, it is possible to preferably employ polyolefin-based resins and silicone-based resins.

As a method for forming the partition members 8, it is possible to employ a method for filling meshes in the permeated-liquid flow-path member 4 with a hot-melt type adhesive agent or other various types of adhesive agents. This increases the flow resistances in directions traversing the partition members. In particular, it is preferable to employ a method for filling the meshes in the permeated-liquid flow-path member 4 with a hot-melt type adhesive agent, in a linear shape in the permeated-liquid flow-path member 4 from its portion proximal to the liquid collection tube 2 up to the element-outer-periphery side, since this method is easy.

Also, it is possible to heat slit yarns made of synthetic-resin films and press the slit yarns onto the permeated-liquid flow-path member for fusing or adhering them to each other, in order to form the partition members 8. This causes the portions to which the slit yarns have been fused or adhered to have a larger thickness, which narrows the gaps between the permeated-liquid flow-path member 4 and the filtration membranes 3 and 5, thereby increasing the flow resistance in directions traversing the partition members.

The aforementioned respective constituents are laminated and wound to form a spiral-type membrane element, thereby assembling the module 1. For fabricating the element and the module, it is possible to employ various types of well-known methods. For example, after the respective constituents have been laminated and wound, they can be fixed at their outer peripheries with a fiber reinforced plastic (FRP) to complete the fabrication of the element. Further, the constituents can be housed within a substantially-cylindrical outer container made of a metal, thereby completing the fabrication of the module.

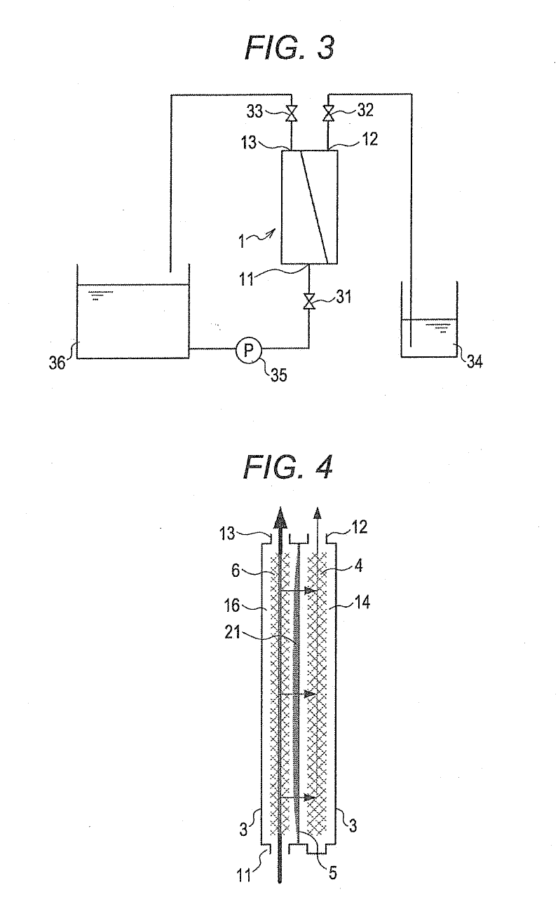

Next, effects of the spiral-type filtration module according to the present invention will be described with reference to FIGS. 3 to 8.

FIG. 3 illustrates a configuration of a filtration system employing the spiral-type filtration module.

During cross-flow operations (including higher-yield operations), a raw-liquid inlet valve 31, a concentrated-liquid outlet valve 33 and a permeated-liquid outlet valve 32 are opened, and a raw liquid is supplied from a raw-liquid tank 36 through a pump 35. The permeated liquid having passed through the filtration membranes is ejected therefrom through the permeated-liquid outlet 12 and is stored in a permeated-liquid tank 34, whereas the concentrated liquid which has not passed through the filtration membranes is ejected through the concentrated-liquid outlet 13 and is returned to the raw-liquid tank 36. During dead-end filtration operations, the concentrated-liquid outlet valve 33 is closed, so that the supplied raw liquid entirely becomes a permeated liquid except for solid substances therein.

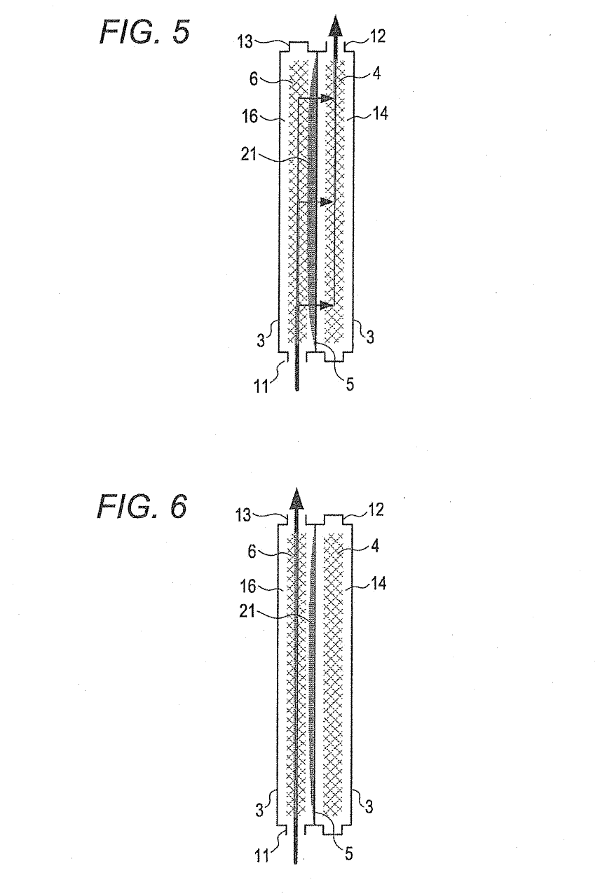

FIG. 4 and FIG. 5 are conceptual views illustrating liquid flows within the filtration module during a cross-flow operation and during a dead-end filtration operation. In FIG. 4 and FIG. 5, the permeated-liquid flow path 14 surrounded by the filtration membrane 3 and the filtration membrane 5 is illustrated on the right side, and the raw-liquid flow path 16 surrounded by the filtration membrane 5 and the filtration membrane 3 is illustrated on the left side. The raw-liquid flow paths and the permeated-liquid flow paths which are adjacent thereto on the both sides of the figures are not illustrated.

During the cross-flow operation (FIG. 4), a portion of the raw liquid supplied to the inside of the module through the raw-liquid inlet 11 passes through the filtration membrane 5, further passes through the permeated-liquid flow path 14, and is ejected therefrom through the permeated-liquid outlet 12, whereas the remainder passes through the raw-liquid flow path 16 and is ejected through the concentrated-liquid outlet 13. At this time, a portion of the solid substances contained in the raw liquid is trapped by the filtration-membrane surfaces to form filtration-membrane-surface deposited substances 21. During the dead-end operation (FIG. 5), the raw liquid supplied to the inside of the module through the raw-liquid inlet 11 is entirely passed through the filtration membrane 5 except for the solid substances contained therein, and is ejected therefrom through the permeated-liquid outlet 12. At this time, the solid substances contained in the raw liquid are trapped by the filtration-membrane surfaces to form filtration-membrane-surface deposited substances 21.

The filtration-membrane-surface deposited substances 21 are eliminated by flushing and the like at regular or irregular time intervals.

The timing of flushing can be determined according to the liquid to be treated, or the like. For example, flushing can be performed at predetermined time intervals, at the time when a pressure difference (a pressure drop) in the filtration module has reached a predetermined magnitude, or based on both the criteria.

Flushing can be performed by closing the permeated-liquid outlet valve 32 and by opening the raw-liquid inlet valve 31 and the concentrated-liquid outlet valve 33, in FIG. 3.

When a flushing liquid is supplied to the inside of the module through the raw-liquid inlet 11, it is entirely ejected therefrom through the concentrated-liquid outlet 13. It is expected that the filtration-membrane-surface deposited substances 21 are washed away by the flushing liquid, and are ejected through the concentrated-liquid outlet 13 together with the flushing liquid (FIG. 6).

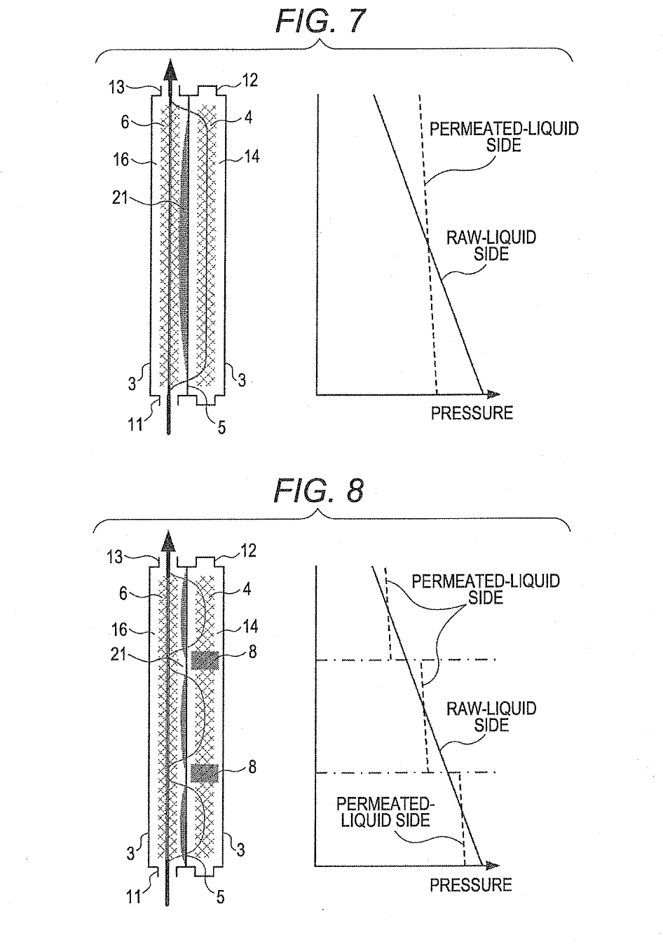

However, in actual, when the flow resistance in the raw-liquid flow path 16 has been increased since the flushing liquid containing such deposited substances eliminated from the filtration-membrane surfaces has been flowed therethrough, a bypass phenomenon that the flushing liquid is diverted to the permeated-liquid flow path 14 occurs, which prevents the deposited substances 21 existing in the midstream of the filtration module from being eliminated thereby (FIG. 7). In filtration modules designed to be suitable for higher-yield operations and dead-end filtration operations, particularly, the permeated-liquid flow path 14 has a lower flow resistance therein, and therefore, such bypass phenomena can prominently occur.

On the contrary, with the filtration module according to the present invention, the partition members 8 formed in the permeated-liquid flow-path member 4 inhibit the fluid from flowing through the permeated-liquid flow path 14 in the module axial direction, thereby suppressing bypass phenomena (FIG. 8).

The filtration operation method, the flushing method, and the like, in the liquid treatment method according to the present invention, are not limited to those described above, and various changes can be made thereto. For example, although a system which utilizes a raw liquid as a flushing liquid is illustrated in FIG. 3, the present invention is not limited thereto, and liquids other than the raw liquid may be utilized as a flushing liquid. Further, in the above description, the raw-liquid inlet 11 is utilized as a port for supplying the flushing liquid, and the concentrated-liquid outlet 13 is utilized as a port for ejecting the flushing liquid (flushing in the forward direction). On the contrary, it is also possible to supply the flushing liquid through the concentrated-liquid outlet 13 and to eject the flushing liquid through the raw-liquid inlet 11 (flushing in the rearward direction). Also, it is possible to perform chemical-agent washing using a chemical agent such as a sodium hypochlorite solution as required, which can eliminate solid substances having intruded into fine pores, which cannot be eliminated only by flushing.

### Experiment 1 and Experiment 2

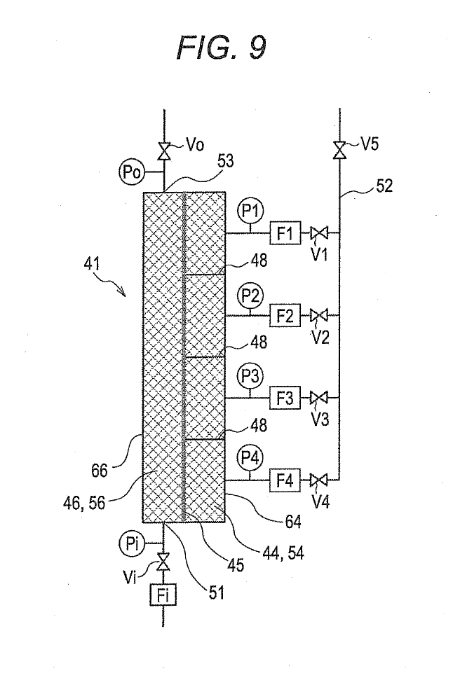

In experiments using an actual filtration module, it is difficult to directly observe occurrences of flushing-liquid-bypassing phenomena and the effect of suppressing the phenomena through the partition members 8. Therefore, model experiments using a device illustrated in FIG. 9 were conducted for verifying them. This device was adapted to model a portion of a spiral-type filtration element, as a flat plate.

The experiment device in FIG. 9 was fabricated as follows.

A raw-liquid flow-path member 46 and a transparent resin plate 66 were made to contact at its one side, in this order, with a filtration membrane 45 having a width of 180 mm and a length of 950 mm, whereas a permeated-liquid flow-path member 44 and another transparent resin plate 64 were made to contact therewith at the other side thereof, in this order, such that the filtration membrane 45 was sandwiched therebetween to form a raw-liquid flow path 56 and a permeated-liquid flow path 54. Further, their peripheral edge portions were sealed with a silicone resin sealant.

The filtration membrane 45 employed therein was a filtration membrane with a nominal pore size of 0.25 μm which was formed from a non-woven fabric made of a synthetic resin, and polymer membranes with a plurality of fine pores which were formed on the opposite surfaces of the nonwoven fabric. As the raw-liquid flow-path member 46 and the permeated-liquid flow-path member 44, nets formed from polyethylene filaments intersecting sterically with each other were used, wherein the filaments had a diameter of 0.35 mm, the nets had a thickness of 0.65 mm, and the density of the filaments was 4.3 filaments/cm.

In the permeated-liquid flow-path member 44, three linear-shaped partition members 48 with a width of 8 mm had been preliminarily formed using a silicone-resin sealant. Therefore, the permeated-liquid flow path 54 was partitioned into four sections each having a width of 180 mm and a length of 210 mm. To the sections of the permeated-liquid flow path 54 (hereinafter, may be simply referred to as “sections”), communication pipes having pressure gages (P1 to P4 in FIG. 9), flowmeters (F1 to F4 in FIG. 9), and valves (V1 to V4 in FIG. 9) were respectively connected.

Experiments 1 and 2 were conducted by using pure water and by opening valves Vi and Vo while closing a valve V5. The pure water was supplied through a raw-water inlet 51 (in a lower side in FIG. 9), and the inlet pressure Pi and the outlet pressure Po were controlled to be constant values of 200 kPa and 50 kPa, respectively.

Experiment 1 was conducted in a state where the valves V1 to V4 were closed. By closing the valves V1 to V4, the liquid was inhibited from flowing between the respective sections without passing through the filtration membrane 45. Therefore, Experiment 1 was an experiment for modeling flushing in cases where the partition members were formed in the permeated-liquid flow path member (the filtration module according to the present invention).

Experiment 2 was conducted in a state where the valves V1 to V4 were opened. Experiment 2 was an experiment for modeling flushing in cases where no partition member was formed in the permeated-liquid flow path member (a conventional filtration module).

Table 1 illustrates the results of the experiments. In Table 1, positive and negative values of the flow rates are illustrated, assuming that Fi had a positive value when the water was flowed into the raw-liquid flow path 56 (when the water passed through a flow-meter Fi in the upward direction in FIG. 9), and F1 to F4 had positive values when the water was flowed out of the permeated-liquid flow path 54 (when the water passed through the flow-meters F1 to F4 in the rightward direction in FIG. 9).

In Experiment 1, there was no flow passing through the flow-meters, since the valves V1 to V4 were closed. Referring to Table 1, the pressures P1 to P4 in the respective sections in the filtrate side had different values, wherein these pressures were gradually lowered from P4 in the section near the inlet (in the upstream side) to P1 in the section near the outlet (in the downstream side). It is considered that P1 to P4 had substantially the same values as those of the raw-liquid-side pressures corresponding to the respective sections. Accordingly, as illustrated in FIG. 8, there is a possibility that bypass flows occurred in the respective sections, but it is considered that the amounts of these bypassing flows were significantly small.

Experiment 2 was conducted in a state where the valves V1 to V4 were opened. Referring to Table 1, the pressure within the permeated-liquid flow path 54 was averaged over its entirety. As a result, in the upstream side, the permeated-liquid-side pressure was lower than the raw-liquid-side pressure, and therefore, the water moved from the raw-liquid side to the permeated-liquid side through the filtration membrane 45 (F4 and F3). In the downstream side, the permeated-liquid-side pressure was higher than the raw-liquid-side pressure, and therefore, the water moved from the permeated-liquid side to the raw-liquid side through the filtration membrane 45 (F1 and F2). In Experiment 2, the flow rate of bypassing flows was F1+F2=F3+F4=1.1 L/min and, therefore, reached nearly half the total flow rate of water, which was 2.4 L/min (Fi).

TABLE 1

| | | Experiment 1 | Experiment 2 |
|---|---|---|---|
| Valve | Vi, Vo | Open | Close |
| | V5 | Close | Close |
| | Vi to V4 | Close | Close |
| Pressure | Po | 50 | 50 |
| (kPa) | P1 | 77 | 130 |
| | P2 | 121 | 130 |
| | P3 | 151 | 130 |
| | P4 | 181 | 130 |
| | Pi | 200 | 200 |
| Flow rate | F1 | — | −0.9 |
| (L/min) | F2 | — | −0.2 |
| | F3 | — | 0.2 |
| | F4 | — | 0.9 |
| | Fi | 1.5 | 2.4 |

### Experiment 3

As Experiment 3, an experiment was conducted for modeling a dead-end filtration operation, in a case where the partition members were formed in the permeated-liquid flow-path member (the filtration module according to the present invention). Experiment was conducted by using the device illustrated in FIG. 9, by closing the valve Vo while opening the valve Vi and the valves V1 to V5, and by supplying, through the raw-liquid inlet 51, a liquid containing pure water added with powders of an activated carbon and pigment which were suspended therein in a concentration of about 300 ppm as solid content.

After the experiment, the filtration-membrane surfaces were observed. This revealed that there was no filtration-membrane-surface deposited substance adhered thereto, at the boundaries between the sections, that is, in the portions where the partition members were formed in the permeated-liquid flow-path member. This is because the filtration did not progress at the boundaries between the sections. Accordingly, there was a level difference between the filtration-membrane surface and the deposited-substance-layer surface at the upstream-side boundary portion in each section, and during flushing, the level-difference portion will be intensively subjected to the pressure of the flow of the flushing liquid. Therefore, it is considered that, even when dense deposited-substance layers less prone to be destructed were formed, these deposited-substance layers could be easily destructed, with their end sides in the upstream sides of the sections as base points.

Further, visual observations were conducted during the experiment. As a result, since no filtration-membrane-surface deposited-substance layer was formed at the section boundaries, the flushing liquid showed a tendency to spread in the directions of the section boundaries (in the directions orthogonal to the flow thereof) at these portions. That is, there was observed a flow regulation effect of uniformly spreading the flow in the raw-liquid flow path. In conventional spiral-type filtration modules, in the event of the occurrence of foreign substances lodged in the raw-liquid flow-path member, or the like, flow anomalies have occurred, and flows have not reached portions downstream of such foreign substances, thereby inducing troubles such as washing malfunctions, clogging in the flow-path member, in some cases. On the contrary, with the spiral-type filtration module according to the present invention, it is possible to detain such flow anomalies within a single section, due to the flow-regulation effect at the section boundaries. This is also an effect of the partition members formed in the permeated-liquid flow-path member.

Next, there will be described effects of manipulations for pressure equalization within the module before flushing, in a liquid treatment method using the spiral-type filtration module according to the present invention, based on results of experiments.

### Experiments 4 to 7

Experiments 4 to 7 were conducted by varying the number of sections in the device in FIG. 9, among 1, 2, 4 and 8. A dead-end filtration operation was performed similarly to Experiment 3 to form a deposited-substance layer on the entire surface of the filtration-membrane surface, using a liquid containing pure water added with powders of an activated carbon and pigment which were suspended therein in a concentration of about 300 ppm as solid content. Next, manipulations for pressure equalization within the experiment device were performed, then flushing was performed, and visual verifications were conducted for the effect of eliminating the filtration-membrane-surface deposited substances.

The pressure-equalization manipulations were manipulations for substantially equalizing the pressure within the device. More specifically, the aforementioned suspension liquid was supplied by opening Vi, with Vo and V1 to V4 kept closed, while waiting for a state where P1 to P4 read substantially the same pressure as Pi. The time period required for attaining the pressure equalization was about 15 seconds, when Pi was 100 kPa. Further, the time period required therefor was about 10 seconds, when Pi was 200 kPa. Further, in cases of employing an actual filtration module, the time period required for pressure equalization within the module depends on the interior capacity of the module, the supply pressure for the flushing liquid, the hydraulic resistance of filtration-membrane-surface deposited-substance layers, the hydraulic resistances of the filtration membranes, and the like.

After the pressure-equalization manipulations, flushing was performed by opening Vo, from the state of the valves during the pressure-equalization manipulations.

Table 2 illustrates the result of the experiment.

In the filtration-membrane surface, after the experiment, there were portions where the filtration-membrane-surface deposited-substance layer had been completely exfoliated and eliminated therefrom, from the downstream ends of the sections to certain distances therefrom. In Table 2, “Length of Portion where Deposited-Substance Layer was Exfoliated” indicates the lengths of the portions where the deposited-substance layer had been completely exfoliated and eliminated, from the downstream ends of these sections.

In Experiments 4 to 6, portions where the deposited-substance-layer had been completely exfoliated and eliminated were observed in many sections. When flushing was performed without performing pressure-equalization manipulations, the deposited-substance layer was not completely exfoliated and eliminated, although the thickness of the deposited-substance layer was reduced. Therefore, from the results of these experiments, it was confirmed that the filtration-membrane-surface deposited substances could be eliminated more efficiently, by performing the manipulations for pressure equalization within the experiment device before flushing.

Further, in comparison between the results of Experiments 4 and 5, the lengths of respective single sections were 950 mm and 420 mm, one of which was substantially twice the other, but the lengths of the exfoliated layers in the respective sections 1 were 200 mm and 180 mm, which were not largely different from each other. This was because the permeation of the experiment water from the permeated-liquid flow-path to the raw-liquid flow-path was concentrated in the downstream side in the module. As a result, the total sum of the lengths of the deposited-substance layers which had been exfoliated in all the sections was larger in Experiment 5 (230 mm) than in Experiment 4 (200 nm).

In Experiment 6, the number of sections was increased to 4, and the total sum of the lengths of the deposited-substance layers exfoliated in all the sections was further increased to 280 mm. This result indicates that the structure of the filtration module according to the present invention advantageously works for exerting the filtration-membrane-surface washing effect of flushing after the pressure-equalization manipulations.

On the other hand, when the number of separated sections was excessively large, the amount of water passed through the filtration membrane 45 was decreased, which made it impossible to clearly observe boundaries between portions where the deposited-substance layer had been exfoliated and portions where it had not been exfoliated (Experiment 7). However, in Experiment 7, similarly, the filtration-membrane-surface deposited-substance layer was entirely reduced in thickness, and therefore, washing through flushing itself progressed.

From the results of Experiments illustrated in Table 2, it can be seen that the length of a single section is preferably in the range of 105 to 420 mm, in order to exert an enhanced filtration-membrane-surface deposited-substance exfoliating effect, through flushing after pressure-equalization manipulations.

TABLE 2

| | | Experi- | Experi- | Experi- | Experi- |
|---|---|---|---|---|---|
| | | ment 4 | ment 5 | ment 6 | ment 7 |
| Number of Sections | | 1 | 2 | 4 | 8 |
| Size of Single Section | | 180 × 950 | 180 × 420 | 180 × 210 | 180 × 105 |
| (Width × Length, mm) | | | | | |
| Length of | (Down- | 200 | 180 | 150 | 0* |
| Portion | stream | | | | |
| where | Side) | | | | |
| Deposited- | Section 1 | | | | |
| Substance | Section 2 | — | 50 | 100 | 0* |
| Layer was | Section 3 | — | — | 30 | 0* |
| Exfoliated | Section 4 | — | — | 0* | 0* |
| (mm) | Section 5 | — | — | — | 0* |
| | Section 6 | — | — | — | 0* |
| | Section 7 | — | — | — | 0* |
| | Section 8 | | | | 0* |
| | (Upstream | | | | |
| | Side) | | | | |

*The boundary between the portion where deposited substances were exfoliated and the portion where they were not exfoliated were unclear.

However, the thickness of the deposited-substance layer itself was reduced.

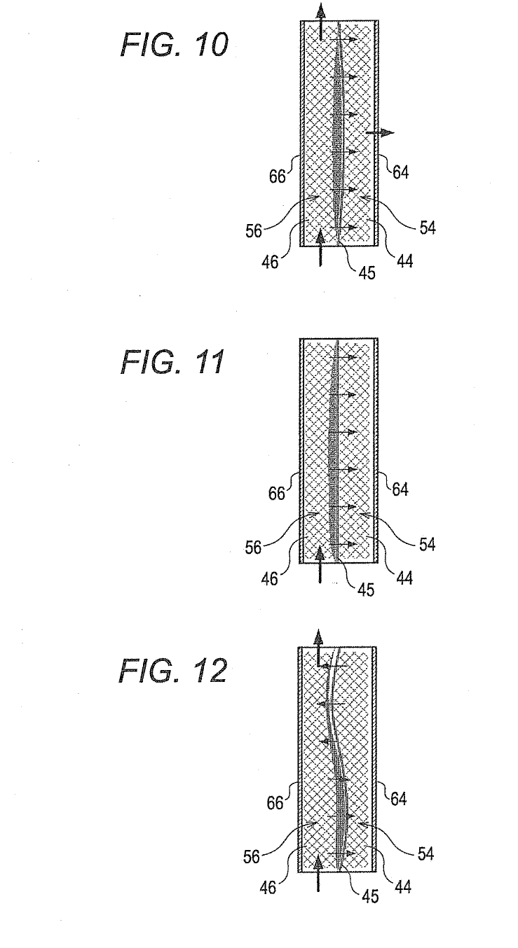

It is considered that, during the series of manipulations in Experiments 4 to 6, the shape of the filtration membrane was changed as in FIGS. 10 to 12.

During the filtration operation, the filtration membrane 45 was slightly expanded from the raw-liquid flow path 56 to the permeated-liquid flow path 54 (FIG. 10). In the aforementioned experiments, the permeated-liquid flow-path member 44 having a lower flow resistance than those in conventional spiral-type modules were employed. Therefore, it is considered that the permeated-liquid flow-path member was more prone to be crushed, and the filtration membrane 45 was largely deformed. Next, when the raw-liquid-flow-path side pressure and the permeated-liquid-flow-path side pressure had been made substantially equal to each other through the pressure-equalization manipulations, the expansion of the filtration membrane 45 was eliminated (FIG. 11). Thereafter, when the flushing was performed by opening the valve Vo, the filtration membrane 45 was pushed toward the raw-liquid flow path 56 from the permeated-liquid flow path 54 in the downstream side of the module (in the upper side in FIG. 12), so that filtration-membrane-surface deposited substances was exfoliated therefrom (FIG. 12). At this time, unlike common back-washing manipulations, the exfoliated deposited substances were effectively washed away toward the downstream side, due to the presence of the flushing liquid being flowed for washing away the deposited substances exfoliated from the filtration-membrane surface.

It is considered that, by performing flushing after pressure-equalization manipulations as described above, it is possible to enhance the effect of exfoliating filtration-membrane-surface deposited substances, due to the utilization of the change of the shape of the filtration membrane, in addition to pressure variations within the experiment device. Further, it is preferable to employ a net having a smaller flow resistance as the permeated-liquid flow-path member in a filtration module suitable for higher-yield operations and dead-end filtration operations. In this case, the shape of the filtration membrane can be largely changed, thereby further enhancing the effect of exfoliating filtration-membrane-surface deposited substances. Further, even for a spiral membrane module having no partition member, such pressure-equalization manipulations have the effect of washing the axial-end portion thereof.

Since the aforementioned phenomena occur in the respective individual sections separated from each other, the effect of exfoliating filtration-membrane-surface deposited substances is prominent in downstream sides of the respective sections.

Therefore, by properly reversing the direction of the flow of the flushing liquid, it is possible to exert this effect over wider ranges in the filtration membrane. That is, by changing over between forward flushing for supplying the flushing liquid through the raw-liquid inlet and rearward flushing for supplying the flushing liquid through the concentrated-liquid outlet, every time flushing has been performed one or more times, it is possible to exfoliate deposited-substance layers over wider ranges in the filtration membrane.

According to the spiral-type filtration module and the liquid treatment method according to the present invention, it is possible to alleviate the influences of flushing-liquid bypassing phenomena, thereby obtaining an effect of eliminating substances deposited on the filtration membrane surfaces more reliably.

What is claimed is:

1. A spiral-type filtration module comprising:
a liquid collection tube; and
one or more units each including a first filtration membrane, a permeated-liquid flow-path member, a second filtration membrane, and a raw-liquid flow-path member, which are laminated on each other, the one or more units being wound around the liquid collection tube to form a spiral-type membrane element, and the spiral-type membrane element being housed in an outer container, wherein
the permeated-liquid flow-path member includes partition members for inhibiting a permeated liquid from flowing in a module axial direction.

2. The spiral-type filtration module according to claim 1, wherein
the first filtration membrane and the second filtration membrane have a nominal pore size of 0.01 to 10 μm.

3. The spiral-type filtration module according to claim 1, wherein
the filtration module is adapted such that an amount of the permeated liquid per an effective membrane area of the filtration membranes is 0.5 to 4 L/min·m².

4. The spiral-type filtration module according to claim 1, wherein
the partition members are formed in a linear shape in the permeated-liquid flow-path member, from a portion proximal to the liquid collection tube to an element outer periphery.

5. The spiral-type filtration module according to claim 4, wherein
the partition members formed in the linear shape are such that there is an interval of 105 to 420 mm between adjacent partition members in the module axial direction.

6. A liquid treatment method using the spiral-type filtration module according to claim 1, wherein
a ratio of an amount of the permeated liquid filtered by the module to an amount of a raw liquid supplied to the module is equal to or more than 1/10.

7. The liquid treatment method according to claim 6, wherein
the raw liquid contains solid substances in a concentration of 1000 ppm or less.

8. The liquid treatment method according to claim 6, wherein
the raw liquid is seawater, river water, or industrial water.

9. The liquid treatment method according to claim 6, wherein
the filtration module is washed by flushing, and
a flushing liquid is supplied at a pressure of 300 kPa or less, during the flushing.

10. The liquid treatment method according to claim 6, wherein
the filtration module is washed by flushing, and
before the flushing, a module-interior pressure equalization manipulation is performed by supplying a flushing liquid while closing a permeated-liquid outlet and an outlet for ejecting the flushing liquid in the filtration module, and
after the pressure-equalization manipulation, only the outlet for ejecting the flushing liquid is opened for performing the flushing.

11. The liquid treatment method according to claim 10, wherein
the flushing is performed in such a way as to change over between forward flushing for supplying the flushing liquid through a raw-liquid inlet in the filtration module and rearward flushing for supplying the flushing liquid through a concentrated-liquid outlet in the filtration module.

12. A liquid treatment device employing the liquid treatment method according to claim 6.
